(19) United States
(12) Patent Application Publication
(10) Pub. No.: US 2018/0364438 A1
(43) Pub. Date: Dec. 20, 2018

(54) FLAT NON-OPTICAL SURFACE OF AN OPTICAL COMPONENT

(71) Applicant: Intel Corporation, Santa Clara, CA (US)

(72) Inventors: Yang Sun, Chandler, AZ (US); Amanuel M. Abebaw, Chandler, AZ (US); Anna M. Prakash, Chandler, AZ (US); Isidore Ray Salas, Phoenix, AZ (US)

(21) Appl. No.: 15/623,919

(22) Filed: Jun. 15, 2017

(51) Int. Cl. G02B 7/00; B29D 11/00; B29C 45/72; B29C 45/26; G02B 3/00

(52) U.S. Cl. CPC G02B 7/003; B29D 11/0048; B29L 2011/0016; B29C 45/26; G02B 3/00; B29C 45/72

(57) ABSTRACT

Aspects of the embodiments are directed to an optical component with at least one substantially flat surface. The flat surface can be used as a surface onto which a pick and place tool can contact the optical component for assembly. The optical component can be formed from a mold that includes an insertable pin. For example, the mold can include a three-piece mold: a core and a cavity can be brought together to define a negative space conforming to a shape of the optical component. The core and the cavity, when brought together, also define an opening. The opening can have a shape that conforms to a desired cross-sectional shape of the flat surface of the optical component. An insertable pin, with a substantially flat end surface, can be inserted through the opening during the mold process to form the substantially flat surface.

### TECHNICAL FIELD

This disclosure pertains to a flat non-optical surface for an optical component and methods of manufacturing a flat non-optical surface for an optical component.

### BACKGROUND

Optical components can be made of plastic materials using molding processes. These plastic optics can be used in optical devices, such as in collimating lens in cameras, compound parabolic collector in solar energy collector and wireless communications, plastic prisms for beam directors, etc. The optical surfaces, through which light beams can pass are usually polished and coated with different thin film materials for added functionality. Other surfaces that are not in the light beam path (e.g., non-optical surfaces) are usually left “as-is” during the mold process, and thus they can either have high roughness or have parting lines and protrusions.

### BRIEF DESCRIPTION OF THE DRAWINGS

FIG. 1 is a schematic diagram of an optical component as a generic example in accordance with embodiments of the present disclosure.

FIG. 2 is a schematic diagram of a three-piece mold for forming an optical component with at least one flat surface in accordance with embodiments of the present disclosure.

FIG. 3 is a process flow diagram for forming an optical component that has at least one flat surface in accordance with embodiments of the present disclosure.

FIG. 4 is a process flow diagram for assembling an optoelectronic device in accordance with embodiments of the present disclosure.

FIG. 5 is a computing device built in accordance with an embodiment of the present disclosure.

Figures may not be drawn to scale.

### DETAILED DESCRIPTION

Described herein are flat non-optical surfaces and methods of manufacturing the same. In the following description, various aspects of the illustrative implementations will be described using terms commonly employed by those skilled in the art to convey the substance of their work to others skilled in the art. However, it will be apparent to those skilled in the art that the present disclosure may be practiced with only some of the described aspects. For purposes of explanation, specific numbers, materials and configurations are set forth in order to provide a thorough understanding of the illustrative implementations. However, it will be apparent to one skilled in the art that the present disclosure may be practiced without the specific details. In other instances, well-known features are omitted or simplified in order not to obscure the illustrative implementations.

Various operations will be described as multiple discrete operations, in turn, in a manner that is most helpful in understanding the present disclosure, however, the order of description should not be construed to imply that these operations are necessarily order dependent. In particular, these operations need not be performed in the order of presentation.

The terms “over,” “under,” “between,” and “on” as used herein refer to a relative position of one material layer or component with respect to other layers or components. For example, one layer disposed over or under another layer may be directly in contact with the other layer or may have one or more intervening layers. Moreover, one layer disposed between two layers may be directly in contact with the two layers or may have one or more intervening layers. In contrast, a first layer “on” a second layer is in direct contact with that second layer. Similarly, unless explicitly stated otherwise, one feature disposed between two features may be in direct contact with the adjacent features or may have one or more intervening layers.

Implementations of the disclosure may be formed or carried out on a substrate, such as a semiconductor substrate. In one implementation, the semiconductor substrate may be a crystalline substrate formed using a bulk silicon or a silicon-on-insulator substructure. In other implementations, the semiconductor substrate may be formed using alternate materials, which may or may not be combined with silicon, that include but are not limited to germanium, indium antimonide, lead telluride, indium arsenide, indium phosphide, gallium arsenide, indium gallium arsenide, gallium antimonide, or other combinations of group III-V or group IV materials. Although a few examples of materials from which the substrate may be formed are described here, any material that may serve as a foundation upon which a semiconductor device may be built falls within the spirit and scope of the present disclosure.

In the optical device assembly process, non-optical surfaces are usually used for component handling/gripping by assembly equipment. In some instances, optical components can sit in a carrier/media at a tilt angle. Non-flatness of these surfaces for handling and gripping can cause assembly equipment picking error and component mis-alignment. For example, if a vacuum pick head is used in the assembly equipment, the parting line introduced by the mold process can cause vacuum leaks, resulting in a weak vacuum picking force or the component picked at a certain tilt angle. The parting line can be a raised portion on a surface of the component that results from the molding process. When the core and the cavity of the mold come together, the interface between the two mold portions allows a small amount of the heated plastic to come through the core-cavity interface. The resulting raised plastic can be referred to as a parting line—a raised line created by the parting of the core from the cavity. Components assembled with a tilt angle can lead to uneven adhesive bond thickness and poor optical & reliability performance.

Although most modern tools/equipment used in assembly industry enabled tilt/rotation compensation, there are certain limits in the degree of compensation. These compensation tools can also involve extensive measurement, component ID mark and traceability, large data processing, and complex automated feed systems. All of these compensation factors can add up in costs and resources. By flattening non-optical surfaces of optical components, the costs and resources used for compensating for vacuum leaks and tilt angles can be mitigated.

The flatness of the non-optical surface can be achieved by using an inserted pin matched to the non-optical surface of the optical component during the mold process of the optical component formation. This pin can be used during the optical component molding process and can be removed with the mold post process. The pin can be made of a glass with high melting temperature to make sure the pin does not contaminate the optical component during the mold process.

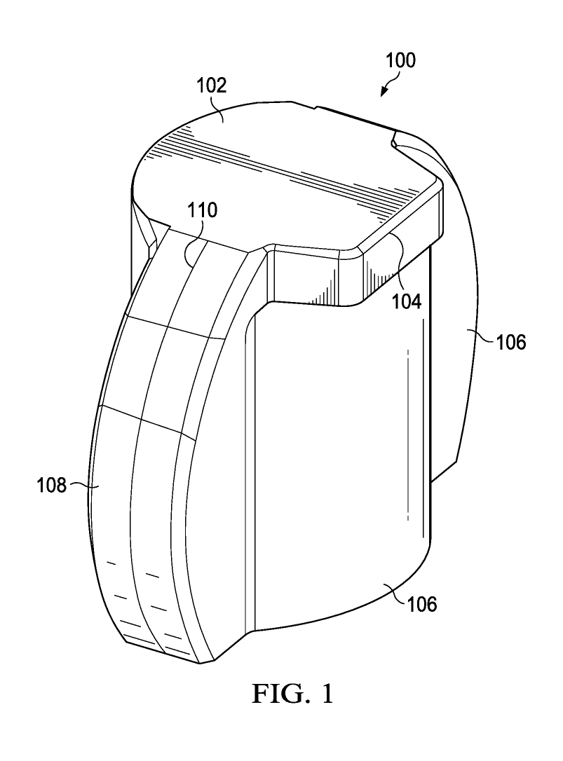

FIG. 1 is a schematic diagram of an example flattened non-optical surface 102 of an optical component 100 in accordance with embodiments of the present disclosure. Optical component 100 is shown as a collimating lens, but it is understood that other optical components are within the scope of this disclosure.

The optical component 100 includes an optical surface 106, such as a collimating lens. The optical component 100 can include one or more interface structures 108. Interface structures 108 can be used to secure the optical component 100 to an optical device.

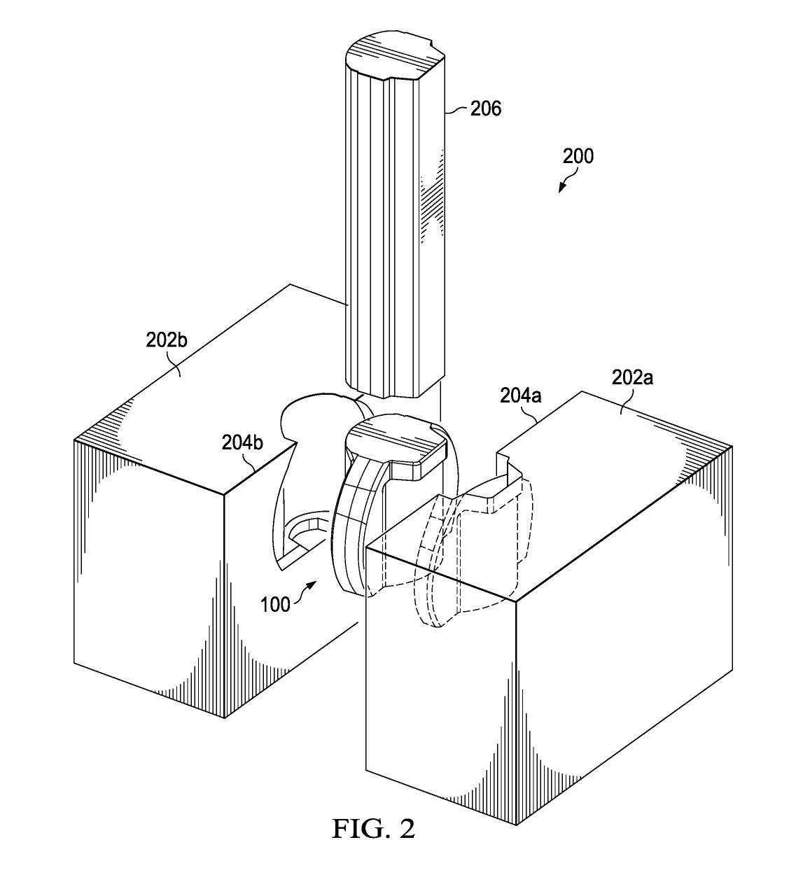

The optical component 100 is formed using a three-piece mold, such as that shown in FIG. 2. The optical component 100 shows parting lines 104 at the edge of surface 102 from the three-piece mold. The optical component 100 also shows parting line 110, which is also from the three-piece mold. The optical component 100 includes a flat surface 102. The flat surface 102 is formed using a pin (shown in FIG. 2) that is shaped to conform to the shape of the desired flat surface.

FIG. 2 is a schematic diagram of a three-piece mold for forming an optical component with at least one flat surface in accordance with embodiments of the present disclosure. The three-piece mold 200 can be used to form a plastic optical component 100 by molding techniques, such as injection molding. The three-piece mold can include a first mold portion 202a and a second mold portion 202b. The first mold portion 202a can include a negative space defines a shape of a first side of the optical component 100. The second mold portion 202b can include a negative space that defines a shape of a second side of the optical component 100. The first mold portion 202a can meet the second mold portion 202b to define a cavity into which a plastic can be injected or otherwise introduced to form the optical component 100 during the molding process. The first mold portion 202a includes a top edge 204a and the second mold portion 202b includes a top edge 204b. The top edges 204a and 204b can result in a parting line, such as parting line 110 from FIG. 1.

After the plastic is introduced to the mold cavity, a pin 206 can be introduced to the mold cavity. The pin 206 can be shaped to conform to a desired top surface 102 of the optical component. The pin 206 can be made of a stainless steel, such as that with high melting temperature to make sure the pin does not contaminate the optical component during the mold process. After the mold has set, the pin 206 can be removed, resulting in a flat (or substantially) top surface 102. The parting lines 104 on the mold will be on the edge of the insert pin 206 instead on down the center of the top surface. By inserting the pin 206 through a top opening of the met first mold portion 202a and the second mold portion 202b, the pin 206 can be guided into place so that the resulting top surface has little or no tilt angle. Also, the use of a pin 206 can result in a flat surface that does not include parting lines down the center of the top surface.

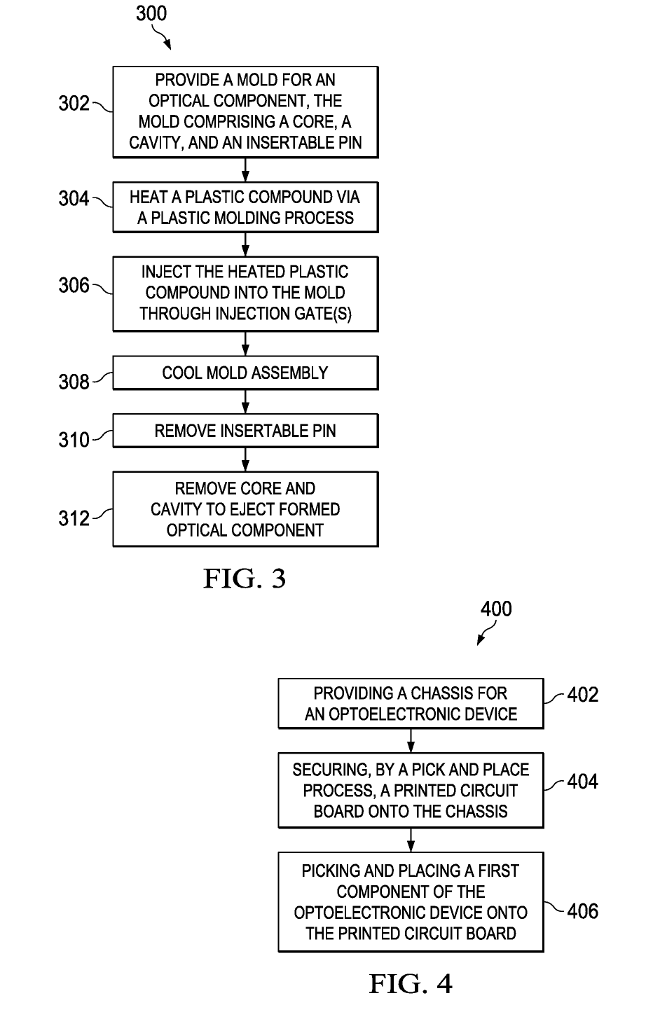

FIG. 3 is a process flow diagram 300 for forming an optical component that has at least one flat surface in accordance with embodiments of the present disclosure. At the outset a three-piece mold can be provided (302). The three-piece mold can include a core and a cavity, that together create a cavity or negative space defining the shape of the optical component. The core and cavity, when placed together, also define an opening for a pin, which is the third portion of the three-piece mold. The pin of the three piece mold includes a flat surface at one end, the flat surface shaped to conform to a desired shape of a flat surface of the optical component.

A plastic compound such as a polycarbonate material can be heated as part of an injection molding process (304). The heated plastic compound can be introduced to the cavity of the mold (306) as part of a molding process, such as an injection molding process. The plastic can be cooled within the mold to create the optical component (308). The pin can also be removed from the optical component surface (310). The core and cavity portions of the mold compound can be removed from the formed optical component (312).

FIG. 4 is a process flow diagram 400 for forming an optical device in accordance with embodiments of the present disclosure. The assembly procedure can be performed by a pick and place processing technology, such as a surface mount technology process. An optoelectronic device chassis can be provided (402). A printed circuit board (PCB) can be placed and secured onto the chassis (404). An optical component of the optoelectronic device can be placed and secured onto the PCB (406). The optical component can be picked by a vacuum pick head at a flat surface of the optical component. Though not explicitly discussed, it is understood that the process can include picking and placing one or more optoelectronic components within the first component. For example, if the optical component can include a collimator lens, the process can also include picking and placing the collimator lens onto the optical device.

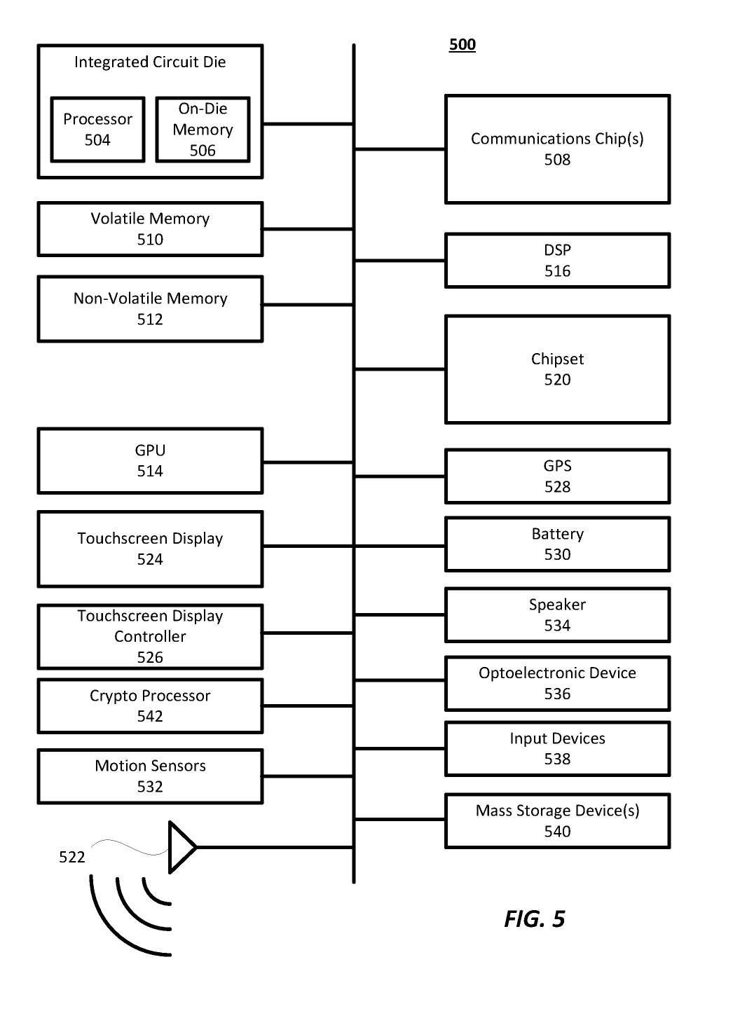

FIG. 5 illustrates a computing device 500 in accordance with one embodiment of the disclosure. The computing device 500 may include a number of components. In one embodiment, these components are attached to one or more motherboards. In an alternate embodiment, some or all of these components are fabricated onto a single system-on-a-chip (SoC) die. The components in the computing device 500 include, but are not limited to, an integrated circuit die 502 and at least one communications logic unit 508. In some implementations the communications logic unit 508 is fabricated within the integrated circuit die 502 while in other implementations the communications logic unit 508 is fabricated in a separate integrated circuit chip that may be bonded to a substrate or motherboard that is shared with or electronically coupled to the integrated circuit die 502. The integrated circuit die 502 may include a CPU 504 as well as on-die memory 506, often used as cache memory, that can be provided by technologies such as embedded DRAM (eDRAM) or spin-transfer torque memory (STTM or STT-MRAM).

Computing device 500 may include other components that may or may not be physically and electrically coupled to the motherboard or fabricated within an SoC die. These other components include, but are not limited to, volatile memory 510 (e.g., DRAM), non-volatile memory 512 (e.g., ROM or flash memory), a graphics processing unit 514 (GPU), a digital signal processor 516, a crypto processor 542 (a specialized processor that executes cryptographic algorithms within hardware), a chipset 520, an antenna 522, a display or a touchscreen display 524, a touchscreen controller 526, a battery 530 or other power source, a power amplifier (not shown), a voltage regulator (not shown), a global positioning system (GPS) device 528, a motion coprocessor or sensors 532 (that may include an accelerometer, a gyroscope, and a compass), a speaker 534, an optoelectronic device 536, user input devices 538 (such as a keyboard, mouse, stylus, and touchpad), and a mass storage device 540 (such as hard disk drive, compact disk (CD), digital versatile disk (DVD), and so forth). Optoelectronic device 536 can include optoelectronic component 100.

The communications logic unit 508 enables wireless communications for the transfer of data to and from the computing device 500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communications logic unit 508 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 500 may include a plurality of communications logic units 508. For instance, a first communications logic unit 508 may be dedicated to shorter range wireless communications such as Wi-Fi and Bluetooth and a second communications logic unit 508 may be dedicated to longer range wireless communications such as GPS, EDGE, GPRS, CDMA, WiMAX, LTE, Ev-DO, and others.

The processor 504 of the computing device 500 includes one or more devices, such as transistors or metal interconnects, that are formed in accordance with embodiments of the disclosure. For example, the processor 504 can include an image signal processor (ISP) and/or one or more application specific integrated circuits (ASICs). The term “processor” may refer to any device or portion of a device that processes electronic data from registers and/or memory to transform that electronic data into other electronic data that may be stored in registers and/or memory.

In various embodiments, the computing device 500 may be a laptop computer, a netbook computer, a notebook computer, an ultrabook computer, a smartphone, a tablet, a personal digital assistant (PDA), an ultra mobile PC, a mobile phone, a desktop computer, a server, a printer, a scanner, a monitor, a set-top box, an entertainment control unit, a digital camera, a portable music player, or a digital video recorder. In further implementations, the computing device 500 may be any other electronic device that processes data.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

These modifications may be made to the disclosure in light of the above detailed description. The terms used in the following claims should not be construed to limit the disclosure to the specific implementations disclosed in the specification and the claims.

The relative sizes of features shown in the figures are not drawn to scale.

The following paragraphs provide examples of various ones of the embodiments disclosed herein.

Example 1 is a method of forming an optical component, the method including applying heated plastic to a cavity of a mold, the mold comprising an opening to receive a pin; inserting the pin into the opening; cooling the plastic shot to form the optical component; removing the pin from the mold; and removing the formed optical component from the mold.

Example 2 may include the subject matter of example 1, wherein the optical component comprises at least one surface that is substantially flat.

Example 3 may include the subject matter of example 2, wherein the optical component comprises a parting line defined by an edge of the substantially flat surface.

Example 4 may include the subject matter of example 1, wherein the pin comprises a flat surface that has a shape that conforms to a desired shape of a flat surface of the optical component.

Example 5 may include the subject matter of any of examples 1-4, and can also include picking the optical component by a vacuum pick head placed onto the surface of the optical component; and placing the optical component onto an optical device using the vacuum pick head.

Example 6 may include the subject matter of example 1, and can also include inserting a second pin into the mold at a second location prior to heating the plastic shot; and after forming the optical component, removing the pin from a surface of the optical component that corresponds to the second location.

Example 7 is an optical component that may include an optical surface; and at least one non-optical surface, the at least one non-optical surface comprising a substantially flat surface and comprising a parting line defining a perimeter edge of the non-optical surface.

Example 8 may include the subject matter of example 7, and can also include at least one alignment surface, the at least one alignment surface comprising a parting line.

Example 9 may include the subject matter of example 7, wherein the optical component comprises a collimator lens.

Example 10 may include the subject matter of example 7, wherein the optical component comprises an injection molded plastic, the optical component being formed from an injection molding process, and wherein the substantially flat surface is formed by an insertable pin that is inserted into a mold, the pin comprising a substantially flat surface having a shape conforming to a shape of the substantially flat surface of the optical component.

Example 11 is a computing device comprising a processor mounted on a substrate; a communications logic unit within the processor; a memory within the processor; a graphics processing unit within the computing device; an antenna within the computing device; a display on the computing device; a battery within the computing device; a power amplifier within the processor; and a voltage regulator within the processor; optoelectronic device, the optoelectronic device comprising an optical component of the optoelectronic device, the optical component comprising at least one substantially flat surface, the substantially flat surface comprising a parting line along an edge of the substantially flat surface.

Example 12 may include the subject matter of example 11, wherein the optical component further comprises at least one alignment surface, the at least one alignment surface comprising a parting line.

Example 13 may include the subject matter of example 11, wherein the optical component comprises a collimator lens.

Example 14 may include the subject matter of example 11, wherein the optical component comprises an injection molded plastic, the optical component being formed from an injection molding process, and wherein the substantially flat surface is formed by an insertable pin that is inserted into a mold, the pin comprising a substantially flat surface having a shape conforming to a shape of the substantially flat surface of the optical component

Example 15 is a mold for forming a plastic optical component, the mold comprising a mold base comprising an opening and a cavity, the cavity defining a negative space conforming to a shape of the plastic optical component, the opening having an outline shaped to conform to an shape of a surface of the plastic optical component; and an insertable pin, the insertable pin comprising a cross-sectional shape conforming to the opening, the insertable pin comprising a substantially flat end surface to be received into the opening.

Example 16 may include the subject matter of example 15, wherein the insertable pin comprises stainless steel.

Example 17 may include the subject matter of example 16, wherein the stainless steel is composed of a material that does not interact chemically with a plastic used to form the plastic optical component.

Example 18 may include the subject matter of example 16, wherein the glass compound comprises a high temperature glass.

Example 19 may include the subject matter of example 15, wherein the mold base comprises a first mold portion and a second mold portion, the first mold portion comprising a first portion of the opening and the second mold portion comprising a second mold portion of the opening.

Example 20 may include the subject matter of example 19, wherein the first mold portion and the second mold portion form a parting line on the plastic optical component, the parting line defining an outline of a substantially flat surface of a formed plastic optical component.

Example 21 may include the subject matter of any of examples 7-10, wherein the non-optical surface is disposed on a top side of the optical component.

Example 22 may include the subject matter of any of examples 7-10 or 21, wherein the optical component comprises a coupler lens.

Example 23 may include the subject matter of any of examples 7-10, wherein the optical component comprises a focusing lens.

Example 24 may include the subject matter of any of examples 1-6, further comprising melting plastic shot to form the heated plastic.

Example 25 may include the subject matter of any of examples 1-6, wherein removing the insertable pin occurs prior to removing the formed optical component from the mold.

Example 26 may include the subject matter of example 1, wherein the parting line comprises a raised linear edge around the perimeter of the non-optical surface.

1. An optical component comprising:
an optical surface; and
at least one non-optical surface, the at least one non-optical surface comprising a substantially flat surface and comprising a parting line defining a perimeter edge of the non-optical surface;
the at least one non-optical surface adjacent to the optical surface.

2. The optical component of claim 1, further comprising at least one alignment surface, the at least one alignment surface comprising a parting line.

3. The optical component of claim 1, wherein the optical surface comprises a collimator lens.

4. The optical component of claim 1, wherein the optical component comprises an injection molded plastic, and wherein the substantially flat surface conforms to a cross-sectional shape of an insertable pin used in a molding process.

5. The optical component of claim 1, wherein the non-optical surface is disposed on a top side of the optical component.

6. The optical component of claim 1, wherein the optical component comprises one of a coupler lens or a focusing lens.

7. The optical component of claim 1, wherein the parting line comprises a raised linear edge around the perimeter of the non-optical surface.

8. A method of forming an optical component, the method comprising:
providing a three-piece mold, the three-piece mold comprising a core, a cavity, and an insertable pin;
injecting a heated plastic into the mold;
cooling the mold and the plastic to form the optical component;
removing the insertable pin from a surface of the optical component; and
removing the formed optical component from the mold.

9. The method of claim 8, wherein the optical component comprises at least one surface that is substantially flat.

10. The method claim 8. wherein the method comprises forming a parting line at an edge of a non-optical surface of the optical component based on a position of the insertable pin and one or both of the core or the cavity.

11. The method of claim 8, wherein the pin comprises a flat surface that has a shape that conforms to a desired shape of a flat surface of the optical component.

12. The method of claim 8, further comprising:
picking the optical component by a vacuum pick head placed onto the surface of the optical component; and
placing the optical component onto an optical device using the vacuum pick head.

13. The method of claim 8, further comprising:
inserting a second pin into the mold at a second location; and
after forming the optical component, removing the second pin from a surface of the optical component that corresponds to the second location.

14. The method of claim 8, further comprising melting plastic shot to form the heated plastic.

15. The method of claim 8, wherein removing the insertable pin occurs prior to removing the formed optical component from the mold.

16. A computing device comprising:
optoelectronic device, the optoelectronic device comprising:
an optical component of the optoelectronic device, the optical component comprising at least one substantially flat surface, the substantially flat surface comprising a parting line along an edge of the substantially flat surface;
the at least one non-optical surface adjacent to the optical surface.

17. The computing device of claim 16, wherein the optical component further comprises at least one alignment surface, the at least one alignment surface comprising a parting line.

18. The computing device of claim 16, wherein the optical component comprises a collimator lens.

19. The computing device of claim 16, wherein the optical component comprises an injection molded plastic, and wherein the substantially flat surface conforms to a cross-sectional shape of an insertable pin used in a molding process.

20. A mold for forming a plastic optical component, the mold comprising:
a mold core and a mold cavity, the mold core and the mold cavity defining a negative space conforming to a shape of the plastic optical component, the mold core and the mold cavity defining an opening, the opening having an outline shaped to conform to an shape of a surface of the plastic optical component; and
an insertable pin, the insertable pin comprising a cross-sectional shape conforming to the opening, the insertable pin comprising a substantially flat end surface to be received into the opening.

21. The mold of claim 20, wherein the insertable pin comprises a stainless steel material.

22. The mold of claim 21, wherein the stainless steel material is composed of a material that does not interact chemically with a plastic used to form the plastic optical component.

23. The mold of claim 21, wherein the stainless steel material comprises a high melting point.

24. The mold of claim 20, wherein the mold core comprising a first portion of the opening and the mold cavity comprising a second mold portion of the opening.

25. The mold of claim 24, wherein the mold core and the mold cavity form a parting line on the plastic optical component, the parting line defining an outline of a substantially flat surface of a formed plastic optical component.
